(19) United States
(12) Patent Application Publication
(10) Pub. No.: US 2008/0239060 A1
(43) Pub. Date: Oct. 2, 2008

(54) IMAGE FORMING APPARATUS AND LASER SCANNING UNIT AND POLYGON MIRROR THEREOF

(75) Inventor: Jun Hyeon JO, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/045,938

(22) Filed: Mar. 11, 2008

(30) Foreign Application Priority Data
Mar. 29, 2007 (KR) 2007-30874

(51) Int. Cl. B41J 2/47; G02B 26/10

(52) U.S. Cl. 347/259; 347/261; 359/208; 359/207

(57) ABSTRACT

An image forming apparatus includes a photoconductor, a laser scanning unit to scan a beam across the photoconductor to form an electrostatic latent image on the photoconductor, a developing unit to apply a developer to the photoconductor having the electrostatic latent image formed thereon to form a visible image on the photoconductor, and a transferring unit to transfer the visible image, formed on the photoconductor, to a print medium. The laser scanning unit includes a light source to generate a beam according to an image signal, a polygon mirror including a plurality of reflection surfaces to deflect the beam, generated by the light source, in the main scanning direction, the reflection surfaces being aspherical to correct an aberration of the beam to converge the beam, deflected in the main scanning direction, on the photoconductor, and a motor to rotate the polygon mirror.

### CROSS-REFERENCE TO RELATED APPLICATION

This application claims the benefit of Korean Patent Application No. 2007-30874 filed on Mar. 29, 2007, in the Korean Intellectual Property Office, the disclosure of which is incorporated herein by reference in its entirety.

### BACKGROUND OF THE INVENTION

1. Field of the Invention

Aspects of the invention relate to an image forming apparatus, and, more particularly, to an image forming apparatus that forms an image by scanning a beam across a photoconductor and a laser scanning unit and a polygon mirror thereof.

2. Description of the Related Art

Generally, an image forming apparatus is an apparatus that prints a black-and-white image or a color image on a print medium, such as paper, according to an image signal. Typical examples of such an image forming apparatus are a laser printer, an inkjet printer, a copier, a multi-function printer, and a facsimile machine. The image forming apparatus forms an image using, for example, an electrophotographic process in which a beam is scanned across a photoconductor to form an electrostatic latent image on the photoconductor, a developer is applied to the photoconductor to form a visible image on the photoconductor, and the visible image on the photoconductor is transferred to a print medium, or using, for example, an inkjet process in which liquid-phase ink is propelled onto the surface of a print medium according to an image signal to form a visible image on the print medium.

In the image forming apparatus using the electrophotographic process, the surface of the photoconductor is charged to a predetermined electric potential, a beam is scanned across the surface of the photoconductor to form an electrostatic latent image on the photoconductor by discharging portions of the photoconductor corresponding to white portions of an image to be formed, and a developer, which is typically a powder, is applied to the electrostatic latent image to form a visible image on the photoconductor. The visible image, formed on the photoconductor, is transferred to a print medium, and then heat and pressure are applied to the print medium to fix the visible image, formed by the developer, to the surface of the print medium.

The image forming apparatus using the electrophotographic process includes a laser scanning unit to scan a beam across the photoconductor according to an image signal to form an electrostatic latent image on the photoconductor. The laser scanning unit includes a light source to generate a beam according to an image signal, a collimator lens to convert the beam, generated by the light source, into a beam parallel with an optical axis, a cylinder lens to convert the collimated beam into a linear beam perpendicular to a sub scanning direction, a polygon mirror to deflect the beam, having passed through the cylinder lens, in a main scanning direction, an F-theta lens to correct an aberration of the beam reflected from the polygon mirror to focus the beam on the photoconductor, and a synchronization detection mirror and a synchronization detection sensor to detect a synchronization signal. These components are typically mounted in a single frame.

An example of such a laser scanning unit is disclosed in U.S. Pat. No. 7,057,781 issued on Jun. 6, 2006. The disclosed laser scanning unit includes scanning optical means including two lenses to scan the beam, reflected from the polygon mirror, uniformly across the surface of the photoconductor in the main scanning direction.

In the conventional laser scanning unit disclosed in U.S. Pat. No. 7,057,781, however, it is necessary to precisely assemble the scanning optical means so that the two lenses are precisely positioned without any error. If either one of the two lenses is incorrectly positioned due to an assembly error, the beam will not be properly converged on the photoconductor, thereby deteriorating an image quality. Consequently, the assembly process is very troublesome.

In addition, the conventional laser scanning unit has a large number of lenses, and therefore, when a frame in which the lenses are mounted is deformed due to heat generated by various parts of the image forming apparatus, a possibility of an optical path distortion is very strong. Such an optical path distortion deteriorates the image quality.

### SUMMARY OF THE INVENTION

Therefore, an aspect of the invention is to provide an image forming apparatus in which the number of parts is reduced to make it easier to perform an assembly process, and to reduce a possibility of the optical path distortion to increase reliability, and a laser scanning unit and a polygon mirror thereof.

According to an aspect of the invention, an image forming apparatus includes a photoconductor; a laser scanning unit including a light source to generate a beam according to an image signal, a polygon mirror comprising a plurality of reflection surfaces to deflect the beam, generated by the light source, in a main scanning direction, the reflection surfaces being aspherical to correct an aberration of the beam to converge the beam, deflected in the main scanning direction, on the photoconductor to form an electrostatic latent image on the photoconductor, and a motor to rotate the polygon mirror; a developing unit to apply a developer to the photoconductor having the electrostatic latent image formed thereon to form a visible image on the photoconductor; and a transferring unit to transfer the visible image, formed on the photoconductor, to a print medium.

According to an aspect of the invention, the aspherical reflection surfaces have a curvature that changes from a center to edges thereof in a direction perpendicular to a rotation axis of the polygon mirror to converge the beam, deflected in the main scanning direction, on the photoconductor in the main scanning direction.

According to an aspect of the invention, the aspherical reflection surfaces have a concave cross-section in a direction parallel to a rotation axis of the polygon mirror to converge the beam, deflected in the main scanning direction, on the photoconductor in a sub scanning direction.

According to an aspect of the invention, the polygon mirror is made of metal.

According to an aspect of the invention, the polygon mirror is made of plastic.

According to an aspect of the invention, the image forming apparatus further includes a lens disposed between the light source and the polygon mirror to guide the beam, generated by the light source, to the polygon mirror.

According to an aspect of the invention, the lens is a collimator lens to convert the beam generated by the light source into a beam parallel with an optical axis.

According to an aspect of the invention, the image forming apparatus further includes a cylinder lens disposed between the polygon mirror and the collimator lens to convert the collimated beam into a linear beam perpendicular to a sub scanning direction.

According to an aspect of the invention, the lens is a condensing lens.

According to an aspect of the invention, a laser scanning unit, of an image forming apparatus including a photoconductor, includes a light source to generate a beam according to an image signal, a polygon mirror including a plurality of reflection surfaces to deflect the beam, generated by the light source, in a main scanning direction, the reflection surfaces being aspherical to correct an aberration of the beam to converge the beam, deflected in the main scanning direction, on the photoconductor; and a motor to rotate the polygon mirror.

According to an aspect of the invention, a polygon mirror, of a laser scanning unit comprising a light source, of an image forming apparatus comprising a photoconductor, is rotatable to deflect a beam, generated by a light source, in a main scanning direction, and includes a plurality of reflection surfaces to deflect the beam, generated by the light source, in the main scanning direction, the reflection surfaces being aspherical to correct an aberration of the beam to converge the beam, deflected in the main scanning direction, on the photoconductor.

According to an aspect of the invention, a polygon mirror is rotatable to deflect a beam in a main scanning direction across a surface, and includes a plurality of reflection surfaces having an aspherical cross-section in a direction perpendicular to a rotation axis of the polygon mirror to correct an aberration of the beam to converge the beam, deflected in the main scanning direction, on the surface in the main scanning direction.

According to an aspect of the invention, the reflection surfaces have a concave cross-section in a direction parallel to the rotation axis of the polygon mirror to converge the beam, deflected in the main scanning direction, on the surface in a sub scanning direction perpendicular to the main scanning direction.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a side sectional view of an image forming apparatus according to an aspect of the invention;

FIG. 2 is a perspective view of a laser scanning unit of the image forming apparatus of FIG. 1 according to an aspect of the invention;

FIGS. 3A and 3B are views of the main scanning direction optical path and the sub scanning direction optical path, respectively, of the laser scanning unit of FIG. 2 according to an aspect of the invention;

FIG. 4 is a plan view of a polygon mirror of a laser scanning unit according to another aspect of the invention;

FIGS. 5A and 5B are views of the main scanning direction optical path and the sub scanning direction optical path, respectively, of a laser scanning unit according to another aspect of the invention; and

FIGS. 6A and 6B are views of the main scanning direction optical path and the sub scanning direction optical path, respectively, of a laser scanning unit according to another aspect of the invention.

### DETAILED DESCRIPTION OF THE EMBODIMENTS

Reference will now be made in detail to embodiments of the invention, examples of which are illustrated in the accompanying drawings, wherein like reference numerals refer to like elements throughout. The embodiments are described below to explain the invention by referring to the figures.

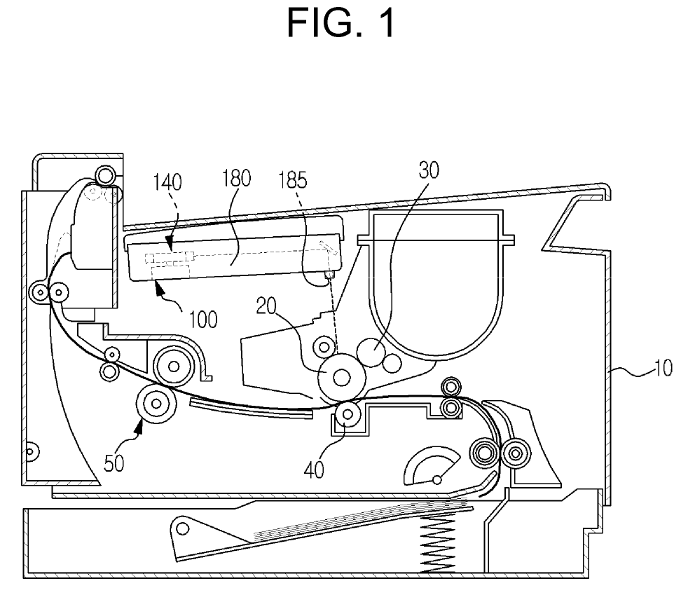

In an image forming apparatus 10 according to an aspect of the invention as shown in FIG. 1, when a laser scanning unit 100 scans a beam across a photoconductor 20 according to an image signal, an electrostatic latent image is formed on the surface of the photoconductor 20. After the electrostatic latent image is formed on the surface of the photoconductor 20, a developing unit 30 applies a developer to the photoconductor 20 to form a visible image on the photoconductor 20. The visible image on the photoconductor 20 is transferred to a print medium by a transferring unit 40 and is fixed to the surface of the print medium by a fixing unit 50.

Other components of the image forming apparatus 10, excluding the laser scanning unit 100, are known to one of ordinary skill in the art, and accordingly a detailed description thereof will not be provided here.

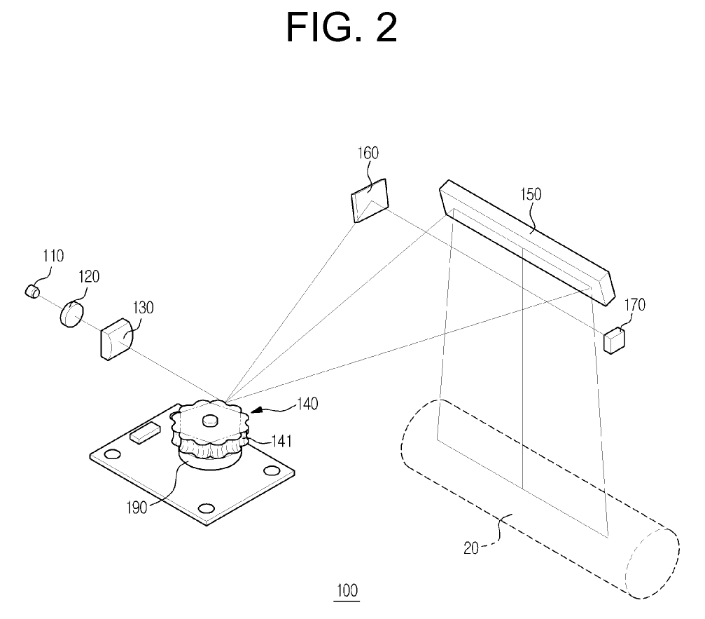

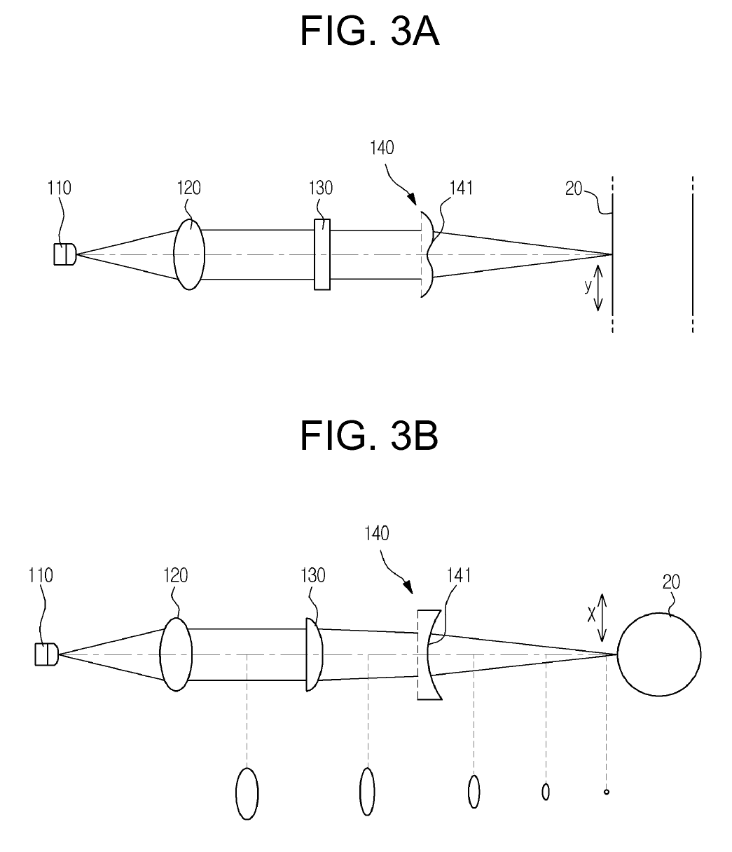

Referring to FIG. 2, the laser scanning unit 100 includes a light source 110, such as a laser diode, to generate a beam, a collimator lens 120 to convert the beam generated by the light source 110 into a beam parallel with an optical axis, a cylinder lens 130 to convert the collimated beam into a linear beam perpendicular to a sub scanning direction x (see FIG. 3B), a polygon mirror 140 to deflect the beam in a main scanning direction y (see FIG. 3A), a reflection mirror 150 to reflect the beam, deflected by the polygon mirror 140, to the photoconductor 20, and a synchronization detection mirror 160 and a synchronization detection sensor 170 to detect a synchronization signal. These components are mounted in a frame 180 to prevent the components from being contaminated due to foreign matter, such as dust. At one side of the frame 180 is disposed an exit window 185, through which the beam, reflected by the reflection mirror 150, exits toward the photoconductor 20.

The polygon mirror 140 has six reflection surfaces 141 to reflect a beam. However, it is understood that the polygon mirror can have more or less than six reflection surfaces. The polygon mirror 140 is rotated at a uniform velocity by a motor 190 fixed to the frame 180. The reflection surfaces 141 of the polygon mirror 140 are aspherical or freeform surfaces having a curvature changing from a center to edges thereof in a direction perpendicular to a rotation axis of the polygon mirror 140 as shown in FIG. 3A. In other words, the reflection surfaces 141 have an aspherical or freeform cross-section in the direction perpendicular to the rotation axis of the polygon mirror 140 as shown in FIG. 3A. The reflection surfaces 141 formed in an aspherical or freeform shape substitute for a conventional F-theta lens that would normally be provided between the polygon mirror 140 and the photoconductor 20 if the image forming apparatus 10 according to an aspect of the invention were a conventional image forming apparatus. The reflection surfaces 141 correct an aberration of the beam incident on the surface of the photoconductor 20. Consequently, the polygon mirror 140, having the aspherical reflection surfaces 141, converges a beam, deflected in the main scanning direction y, uniformly on the surface of the photoconductor 20 along the main scanning direction y.

Also, the aspherical reflection surfaces 141 of the polygon mirror 140 have a concave cross-section in a direction parallel to the rotation axis of the polygon mirror 140 to converge the deflected beam on the photoconductor 20 as shown in FIG. 3B. The reflection surfaces 141 are provided with the concave cross-section to reduce a focal length, and thus a total size, of the laser scanning unit 100. The degree of curvature of the concave cross-section depends on the desired focal length, and is chosen during the process of designing the laser scanning unit 100. However, it is understood that the aspherical reflection surfaces 141 may have a flat cross-section in the direction parallel to the rotation axis of the polygon mirror 140 if it is not necessary to reduce the focal length of the laser scanning unit 100, in which case fabrication of the polygon mirror 140 will be simplified.

The design of the aspherical or freeform reflection surfaces 141 of the polygon mirror 140 may be performed using the following standard aspherical surface equation:

$$z = \frac{{C}_{1} {\vert y \vert}^{2}}{1 + \sqrt{1 - ( 1 + K ) {C}_{1}^{2} {\vert y \vert}^{2}}} + {\sum }_{n} {A}_{n} {\vert y \vert}^{n} + \frac{{C}_{2} ( 1 + {\sum }_{n} {B}_{n} {\vert y \vert}^{n} ) {x}^{2}}{1 + \sqrt{1 - {C}_{2}^{2} ( 1 + {\sum }_{n} {B}_{n} {\vert y \vert}^{n} ) {x}^{2}}}$$

Here, z is the surface depth of the lens in the propagation direction of the beam, C₁ is the central curvature value in the main scanning direction, K is the conic coefficient, Aₙ is the order deformation coefficient in the main scanning direction, C₂ is the central curvature value in the sub scanning direction, Bₙ is the order deformation coefficient in the sub scanning direction, y is the coordinate in the main scanning direction, and x is the coordinate in the sub scanning direction.

The standard aspherical surface equation defines the curved shape of an aspherical lens or reflecting body. The various coefficient values may be calculated using optical design software (e.g., Code V optical design software available from Optical Research Associates (ORA)) used in fundamental aspherical surface design, and the curved surface design in the main scanning direction y and the sub scanning direction x is possible based on the calculated coefficient values.

The polygon mirror 140, having the aspherical reflection surfaces 141, may be made of metal or plastic.

When the polygon mirror 140 is made of metal, it is possible to form the aspherical reflection surfaces 141 of the polygon mirror 140 using various known metal processing technologies (e.g., five-axis machining).

When the polygon mirror 140 is made of plastic, it is possible to form the polygon mirror 140 using a well-known epoxy molded compound (EMC) resin. The EMC resin has a contraction rate less than and an elastic modulus higher than polyethylene (PE), polypropylene (PP), and polystyrene (PS) resins. However, it is understood that when the polygon mirror 140 is made of plastic, the plastic is not limited to the materials listed above, other types of plastics may be used.

When a plastic material is injection-molded, using a mold, to form the polygon mirror 140, the shape of an ejector pin of the mold may be changed to obtain the aspherical or freeform reflection surfaces 141 having a desired design value.

When the polygon mirror 140 is made of plastic, it must be coated with a reflective material to be able to reflect the beam. Examples of a suitable reflective material having a high reflectivity include silver (Ag), aluminum (Al), and silicon dioxide (SiO₂). A micromachining method, such as sputtering, may be used to coat the polygon mirror 140 with the reflective material.

The polygon mirror 140, made of the metal or plastic material and having aspherical reflection surfaces 141, is rotated, at a uniform velocity, to deflect the beam in the main scanning direction y, and, at the same time, to converge the deflected beam uniformly on the photoconductor 20 in the main scanning direction y.

FIGS. 3A and 3B are views of the main scanning direction optical path and the sub scanning direction optical path, respectively, of the laser scanning unit 100 according to an aspect of the invention.

As shown in FIGS. 3A and 3B, a beam generated by the light source 110 of the laser scanning unit 100 is converted into a beam parallel with an optical axis by the collimator lens 120, and then converted into a linear beam perpendicular to the sub scanning direction x while passing through the cylinder lens 130. Subsequently, the beam, having passed through the cylinder lens 130, is reflected by the reflection surfaces 141 of the polygon mirror 140, which is rotated at a uniform velocity, whereby the beam is deflected to the photoconductor 20 in the main scanning direction y.

The beam, reflected by the polygon mirror 140, is converged uniformly on the photoconductor 20 in the main scanning direction y because the aspherical reflection surfaces 141 of the polygon mirror 140 have an aspherical cross-section as shown in FIG. 3A. Consequently, the laser scanning unit 100 according to an aspect of the invention does not require an F-theta lens to converge the deflected beam uniformly on the photoconductor 20.

Also, the beam, reflected by the polygon mirror 140, is converged on the photoconductor 20 in the sub scanning direction x by the combined action of the cylinder lens 130 and the concave cross-section of the aspherical reflection surfaces 141 shown in FIG. 3B. Consequently, it is possible to reduce the focal length, and thus the total size, of the laser scanning unit 100.

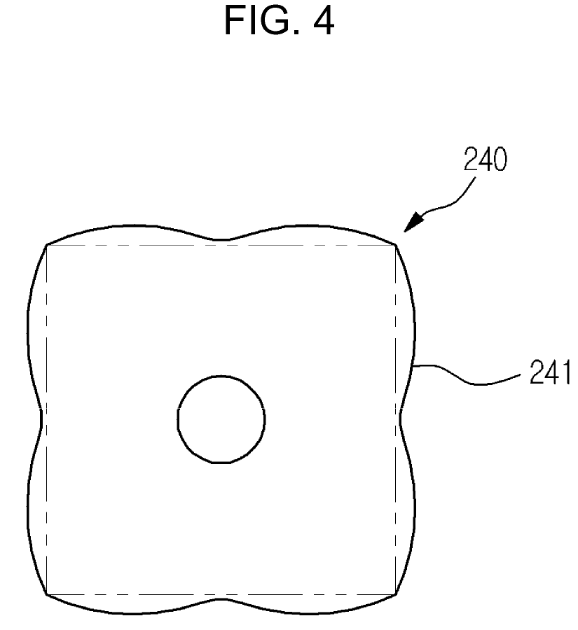

FIG. 4 is a plan view of a polygon mirror 240 of a laser scanning unit according to an aspect of the invention. The polygon mirror 240 has four reflection surfaces 241. The reflection surfaces 241 of the polygon mirror 240 are aspherical or freeform surfaces. Consequently, it is possible for the polygon mirror 240 to converge the deflected beam uniformly in the main scanning direction y. However, it is understood that the number of the aspherical or freeform reflection surfaces 241 of the polygon mirror may be more or less than four.

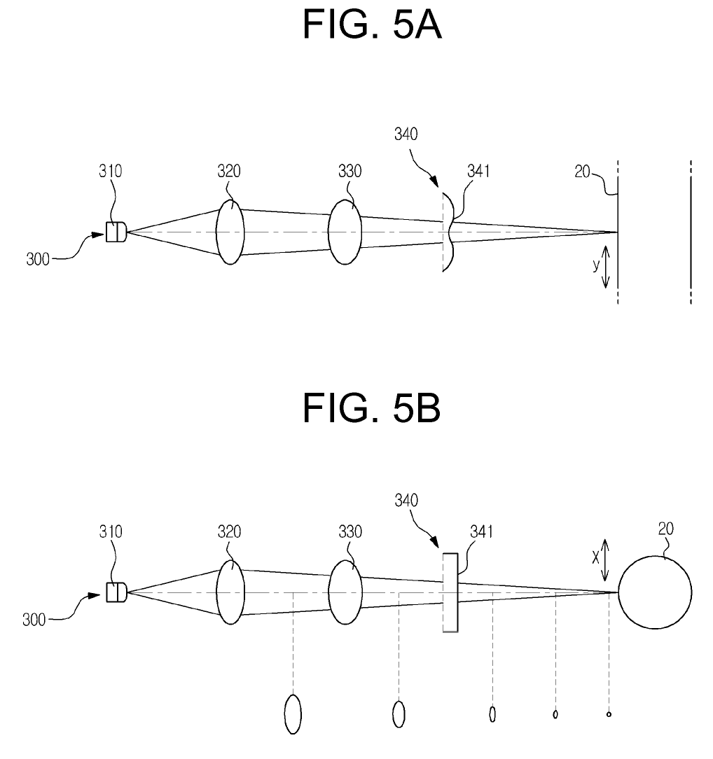

FIGS. 5A and 5B are views of the main scanning direction optical path and the sub scanning direction optical path, respectively, of a laser scanning unit 300 according to another aspect of the invention.

The laser scanning unit 300 includes a light source 310 to generate a beam, two condensing lenses 320 and 330 to converge the beam generated by the light source 310, and a polygon mirror 340 rotatable at a uniform velocity to deflect the beam, having passed through the condensing lenses 320 and 330, in the main scanning direction y. The polygon mirror 340 has a plurality of aspherical or freeform reflection surfaces 341, like the polygon mirror 140 according to the aspect of the invention shown in FIGS. 1, 2, 3A, and 3B.

The laser scanning unit 300 converges the beam, generated by the light source 310, uniformly on the surface of the photoconductor 20 in the main scanning direction y using the polygon mirror 340 having the aspherical reflection surfaces 341 without using an F-theta lens.

The beam generated by the light source 310 is converged by the two condensing lenses 320 and 330. Consequently, the deflected beam is converged on the photoconductor 20 in the sub scanning direction x even though the aspherical reflection surfaces 341 of the polygon mirror 340 do not have a concave cross-section in the direction parallel to the rotation axis of the polygon mirror 340. The focal length of the laser scanning unit 300 is established by adjusting the distance between the two condensing lenses 320 and 330 according to the characteristics of the condensing lenses 320 and 330.

Although not shown in FIGS. 5A and 5B, the laser scanning unit 300 further includes a motor 190 to rotate the polygon mirror 340, a synchronization detection mirror 160 and a synchronization detection sensor 170 to detect a synchronization signal, a reflection mirror 150, and a frame 180 (see FIG. 1), like the laser scanning unit 100 shown in FIG. 2.

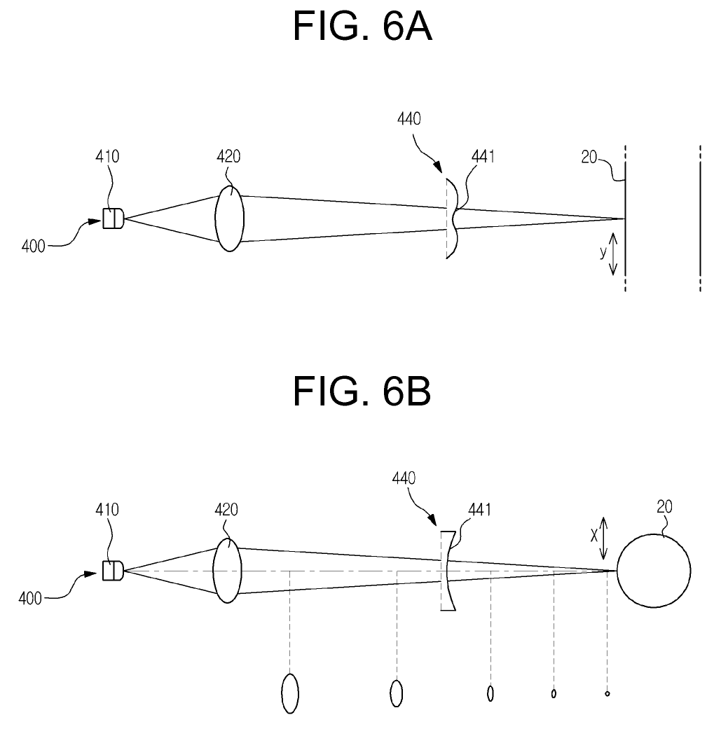

FIGS. 6A and 6B are views of the main scanning direction optical path and the sub scanning direction optical path, respectively, of a laser scanning unit 400 according to another aspect of the invention.

The laser scanning unit 400 includes a light source 410 to generate a beam, a condensing lens 420 to converge the beam generated by the light source 410, and a polygon mirror 440 rotatable at a uniform velocity to deflect the beam, having passed through the condensing lens 420, in the main scanning direction y. The polygon mirror 440 has a plurality of aspherical reflection surfaces 441, like the polygon mirror 140 according to the aspect of the invention shown in FIGS. 1, 2, 3A, and 3B.

The laser scanning unit 400 converges the beam, generated by the light source 410, uniformly on the surface of the photoconductor 20 in the main scanning direction y using the polygon mirror 440 having the aspherical reflection surfaces 441 without using an F-theta lens.

In the laser scanning unit 400, it may be difficult to converge the beam on the surface of the photoconductor 20 in the sub scanning direction x using the single condensing lens 420. For this reason, the reflection surfaces 441 of the polygon mirror 440 have a concave cross-section in a direction parallel to the rotation axis of the polygon mirror 440 to converge the beam on the photoconductor 20 in the sub scanning direction x as shown in FIG. 6B.

Although not shown in FIGS. 6A and 6B, the laser scanning unit 400 further includes a motor 190 to rotate the polygon mirror 440, a synchronization detection mirror 160 and a synchronization detection sensor 170 to detect a synchronization signal, a reflection mirror 150, and a frame 180 (see FIG. 1), like the laser scanning unit 100 shown in FIG. 2.

As apparent from the foregoing description, the reflection surfaces of the polygon mirror that deflect the beam in the main scanning direction are aspherical or freeform surfaces. As a result, it is possible for the polygon mirror to converge the deflected beam uniformly in the main scanning direction. Consequently, a laser scanning unit according to an aspect of the invention does not require a conventional F-theta lens to converge the beam uniformly in the main scanning direction, and therefore, it is unnecessary to install the conventional F-theta lens at a precise position without any error during assembly as is required in a conventional laser scanning unit.

Also, it is unnecessary that an optical component, such as the conventional F-theta lens, be disposed between the polygon mirror and the reflection mirror. Consequently, a possibility of the optical path distortion is greatly reduced when a frame supporting various optical components is deformed.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus comprising:
a photoconductor;
a laser scanning unit comprising:
a light source to generate a beam according to an image signal;
a polygon mirror comprising a plurality of reflection surfaces to deflect the beam, generated by the light source, in a main scanning direction, the reflection surfaces being aspherical to correct an aberration of the beam to converge the beam, deflected in the main scanning direction, on the photoconductor to form an electrostatic latent image on the photoconductor; and
a motor to rotate the polygon mirror;
a developing unit to apply a developer to the photoconductor having the electrostatic latent image formed thereon to form a visible image on the photoconductor; and
a transferring unit to transfer the visible image, formed on the photoconductor, to a print medium.

2. The image forming apparatus of claim 1, wherein the aspherical reflection surfaces have a curvature that changes from a center to edges thereof in a direction perpendicular to a rotation axis of the polygon mirror to converge the beam, deflected in the main scanning direction, on the photoconductor in the main scanning direction.

3. The image forming apparatus of claim 1, wherein the aspherical reflection surfaces have a concave cross-section in a direction parallel to a rotation axis of the polygon mirror to converge the beam, deflected in the main scanning direction, on the photoconductor in a sub scanning direction.

4. The image forming apparatus of claim 1, wherein the polygon mirror is made of metal.

5. The image forming apparatus of claim 1, wherein the polygon mirror is made of plastic.

6. The image forming apparatus of claim 1, further comprising a lens disposed between the light source and the polygon mirror to guide the beam, generated by the light source, to the polygon mirror.

7. The image forming apparatus of claim 6, wherein the lens is a collimator lens to convert the beam generated by the light source into a beam parallel with an optical axis.

8. The image forming apparatus of claim 7, further comprising a cylinder lens disposed between the polygon mirror and the collimator lens to convert the collimated beam into a linear beam perpendicular to a sub scanning direction.

9. The image forming apparatus of claim 6, wherein the lens is a condensing lens.

10. A laser scanning unit of an image forming apparatus comprising a photoconductor, the laser scanning unit comprising:
a light source to generate a beam according to an image signal;
a polygon mirror comprising a plurality of reflection surfaces to deflect the beam, generated by the light source, in a main scanning direction, the reflection surfaces being aspherical to correct an aberration of the beam to converge the beam, deflected in the main scanning direction, on the photoconductor; and
a motor to rotate the polygon mirror.

11. The laser scanning unit of claim 10, wherein the aspherical reflection surfaces have a curvature that changes from a center to edges thereof in a direction perpendicular to a rotation axis of the polygon mirror to converge the beam, deflected in the main scanning direction, on the photoconductor in the main scanning direction.

12. The laser scanning unit of claim 10, wherein the aspherical reflection surfaces have a concave cross-section in a direction parallel to a rotation axis of the polygon mirror to converge the beam, deflected in the main scanning direction, on the photoconductor in a sub scanning direction.

13. The laser scanning unit of claim 10, wherein the polygon mirror is made of metal.

14. The laser scanning unit of claim 10, wherein the polygon mirror is made of plastic.

15. The laser scanning unit of claim 10, further comprising a lens disposed between the light source and the polygon mirror to guide the beam, generated by the light source, to the polygon mirror.

16. The laser scanning unit of claim 15, wherein the lens is a collimator lens to convert the beam generated by the light source into a beam parallel with an optical axis.

17. The laser scanning unit of claim 16, further comprising a cylinder lens disposed between the polygon mirror and the collimator lens to convert the collimated beam into a linear beam perpendicular to a sub scanning direction.

18. The laser scanning unit of claim 15, wherein the lens is a condensing lens.

19. A polygon mirror of a laser scanning unit of an image forming apparatus, the laser scanning unit comprising a light source, the image forming apparatus comprising a photoconductor, the polygon mirror being rotatable to deflect a beam, generated by the light source, in a main scanning direction, the polygon mirror comprising:
a plurality of reflection surfaces to deflect the beam, generated by the light source, in the main scanning direction, the reflection surfaces being aspherical to correct an aberration of the beam to converge the beam, deflected in the main scanning direction, on the photoconductor.

20. The polygon mirror of claim 19, wherein the aspherical reflection surfaces have a curvature that changes from a center to edges thereof in a direction perpendicular to a rotation axis of the polygon mirror to converge the beam, deflected in the main scanning direction, on the photoconductor in the main scanning direction.

21. The polygon mirror of claim 19, wherein the aspherical reflection surfaces have a concave cross-section in a direction parallel to a rotation axis of the polygon mirror to converge the beam, deflected in the main scanning direction, on the photoconductor in a sub scanning direction.

22. The polygon mirror of claim 19, wherein the polygon mirror is made of metal.

23. The polygon mirror of claim 19, wherein the polygon mirror is made of plastic.

24. A polygon mirror that is rotatable to deflect a beam in a main scanning direction across a surface, the polygon mirror comprising:
a plurality of reflection surfaces having an aspherical cross-section in a direction perpendicular to a rotation axis of the polygon mirror to correct an aberration of the beam to converge the beam, deflected in the main scanning direction, on the surface in the main scanning direction.

25. The polygon mirror of claim 24, wherein the reflection surfaces have a concave cross-section in a direction parallel to the rotation axis of the polygon mirror to converge the beam, deflected in the main scanning direction, on the surface in a sub scanning direction perpendicular to the main scanning direction.
